(19) United States
(12) Patent Application Publication
(10) Pub. No.: US 2026/0044104 A1
(43) Pub. Date: Feb. 12, 2026

(54) IMAGE FORMING APPARATUS

(71) Applicant: CANON KABUSHIKI KAISHA, Tokyo (JP)

(72) Inventor: YUKI INOUE, Saitama (JP)

(21) Appl. No.: 19/250,589

(22) Filed: Jun. 26, 2025

(30) Foreign Application Priority Data
Aug. 7, 2024 (JP) 2024-130760

(51) Int. Cl. G03G 15/00; G03G 15/16

(52) U.S. Cl. CPC G03G 15/6561; G03G 15/1615

(57) ABSTRACT

According to an image forming apparatus, for conveyance of the sheet having a first basis weight as a basis weight to the second nip portion, the pair of registration rollers is in the separated state with the sheet at a position to which the sheet is conveyed by a predetermined distance after the leading end in the conveyance direction of the sheet reaches the second nip portion, and for conveyance of the sheet having, as the basis weight, a second basis weight larger than the first basis weight to the second nip portion, the pair of registration rollers is in the abutment state with the sheet at the position to which the sheet is conveyed by the predetermined distance after the leading end in the conveyance direction of the sheet reaches the second nip portion.

### BACKGROUND

### Field of the Technology

The present disclosure relates to an image forming apparatus that forms an image on a sheet.

### Description of the Related Art

An image forming apparatus adopting the electrophotographic system typically performs an image forming process to fix a toner image onto a sheet such as a paper medium through the respective steps of charging, exposing, developing, transferring, and fixing. In addition, an image forming apparatus adopting the intermediate transfer system includes an image forming portion, and an intermediate transfer belt, and performs an image forming process in which a toner image formed by the image forming portion is primarily transferred on the intermediate transfer belt, and then the toner image primarily transferred on the intermediate belt is secondarily transferred onto a sheet fed and conveyed.

The secondarily transferring in such an image forming process is performed on a secondary-transfer nip portion formed with a secondary-transfer outer roller pressing a secondary-transfer inner roller around which the back face of the intermediate transfer belt is stretched, from the front face side of the intermediate transfer belt.

Japanese Patent Application Laid Open No. 2022-71703 discloses an apparatus that applies driving to a secondary-transfer outer roller by a driving source such as a motor. This arrangement results in reduction of transfer misalignment when a toner image is transferred onto a sheet.

Further, a sheet conveyed to a secondary-transfer nip portion is typically subjected to a skew feeding correction by a pair of registration rollers disposed just in front of the secondary-transfer nip portion in order that the sheet is parallel to the secondary-transfer nip portion.

### SUMMARY

When the skew feeding of the sheet is larger due to variation in precision of parts or variation across the ages, the amount of twist of the sheet occurring due to warping of the sheet with the leading end in the conveyance direction of the sheet abutting on the nip portion of the pair of registration rollers may be larger. Then, such a twisted portion of the sheet may be stamped or pressed by the pair of registration rollers, thereby resulting in occurrence of damage to the sheet.

It is desirable to provide an image forming apparatus that enables to prevent an image formed on a sheet from being stretched and shrunk in the conveyance direction of the sheet and prevent the sheet from being damaged by a pair of registration rollers.

An image forming apparatus according to the present disclosure includes: an image forming portion configured to form a toner image; a pair of registration rollers including a first roller member, and a second roller member forming a first nip portion with the second roller member abutting on the first roller member, the pair of registration rollers being configured to convey a sheet while the sheet is being nipped by the first nip portion, and correct skew feeding of the sheet due to abutment of a leading end in a conveyance direction of the sheet on the first nip portion; a separation mechanism configured to switch the pair of registration rollers between an abutment state in which the first nip portion is formed with the first roller member and the second roller member abutting on each other and a separated state in which the first nip portion is separated; a transfer portion including a belt configured to bear the toner image formed by the image forming portion, a transfer member forming a second nip portion with the transfer member abutting on an outer side of the belt, and a driving portion configured to drive the transfer member to rotate, the transfer portion being configured to transfer the toner image onto the sheet while the sheet is passing through the second nip portion after the correction of the skew feeding of the sheet by the pair of registration rollers; and a controller configured to control the separation mechanism, in which for conveyance of the sheet having a first basis weight as a basis weight to the second nip portion, the pair of registration rollers is in the separated state with the sheet at a position to which the sheet is conveyed by a predetermined distance after the leading end in the conveyance direction of the sheet reaches the second nip portion, and for conveyance of the sheet having, as the basis weight, a second basis weight larger than the first basis weight to the second nip portion, the pair of registration rollers is in the abutment state with the sheet at the position to which the sheet is conveyed by the predetermined distance after the leading end in the conveyance direction of the sheet reaches the second nip portion.

Further features of the present disclosure will become apparent from the following description of exemplary embodiments with reference to the attached drawings.

### BRIEF DESCRIPTION OF THE DRAWINGS

FIG. 1 is a schematic view of an image forming apparatus according to an embodiment;

FIG. 2 is a block diagram illustrating the configuration of the image forming apparatus according to the embodiment;

FIG. 3 is a plan view illustrating a state before a sheet skew feeding correction by a pair of registration rollers of the image forming apparatus according to the embodiment;

FIG. 4 is a plan view illustrating a state after the sheet skew feeding correction by the pair of registration rollers of the image forming apparatus according to the embodiment;

FIG. 5 is a plan view illustrating a state in which the pair of registration rollers of the image forming apparatus according to the embodiment has restarted sheet conveyance;

FIG. 6 is a partially schematic view of the image forming apparatus according to the embodiment; and

FIG. 7 is a flowchart illustrating an operation of the image forming apparatus according to the embodiment;

### DESCRIPTION OF THE EMBODIMENTS

Hereinafter, embodiments will be described in detail with reference to the drawings.

### Configuration of Image Forming Apparatus

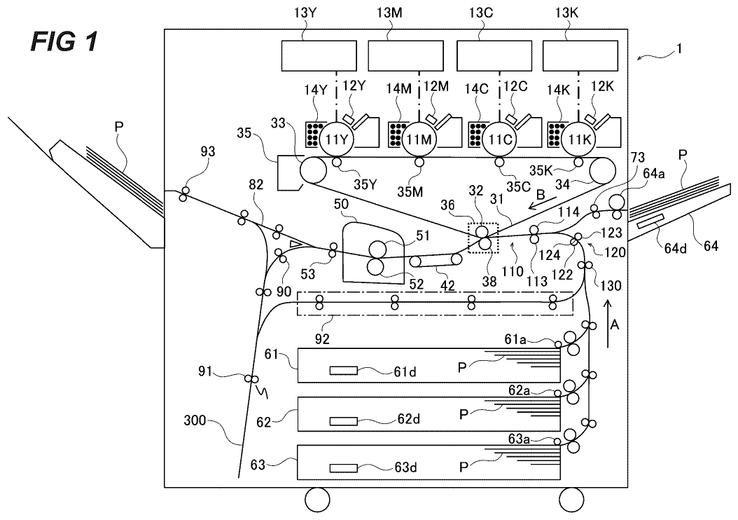

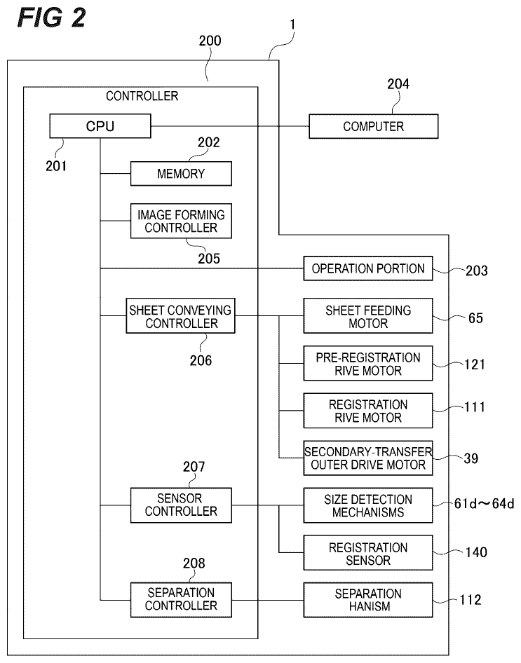

The configuration of an image forming apparatus 1 according to an embodiment of the present disclosure will be described in detail with reference to FIGS. 1 to 4.

The image forming apparatus 1 forms an image on a sheet P. Here, the image forming apparatus 1 is exemplified by a color image forming apparatus adopting the electrophotographic system.

Specifically, the image forming apparatus 1 includes photoconductors 11Y, 11M, 11C, and 11K, charging portions 12Y, 12M, 12C, and 12K, exposure portions 13Y, 13M, 13C, and 13K, and developing portions 14Y, 14M, 14C, and 14K. The image forming apparatus 1 further includes an intermediate transfer belt 31, a driving roller 33, a tension roller 34, primary transfer portions 35Y, 35M, 35C, and 35K, a secondary transfer portion 36, a secondary-transfer outer drive motor 39, and an air-suction conveying portion 42. The image forming apparatus 1 further includes a pair of fixing rollers 50, a pair of post-fixing rollers 53, a sheet storage case 61, a sheet storage case 62, a sheet storage case 63, a manual feeding portion 64, and a sheet feeding motor 65.

The image forming apparatus 1 further includes a pair of reversing first rollers 90, a pair of reversing rollers 91, a duplex conveying portion 92, a pair of discharge rollers 93, a pair of registration rollers 110, a registration drive motor 111, a separation mechanism 112, and a pair of pre-registration rollers 120. Furthermore, the image forming apparatus 1 includes a pre-registration drive motor 121, a pair of conveying rollers 130, a registration sensor 140, a controller 200, an operation portion 203, and a reversing retraction portion 300.

Here, the image forming apparatus 1 includes an image forming portion that forms a toner image. The image forming portion includes the photoconductors 11Y, 11M, 11C, and 11K, the charging portions 12Y, 12M, 12C, and 12K, the exposure portions 13Y, 13M, 13C, and 13K, and the developing portions 14Y, 14M, 14C, and 14K. The intermediate transfer belt 31, the secondary transfer portion 36, and the secondary-transfer outer drive motor 39 are constituents of a transfer portion. The pair of fixing rollers 50 and the pair of post-fixing rollers 53 are constituents of an image fixing portion.

The photoconductors 11Y, 11M, 11C, and 11K are provided corresponding one-to-to colors of yellow (Y), magenta (M), cyan (C), and black (Bk). The photoconductors 11Y, 11M, 11C, and 11K are rotationally driven by a drive motor (not illustrated) driven under the control of an image forming controller 205 that is described later and that the controller 200 includes.

The charging portions 12Y, 12M, 12C, and 12K are provided corresponding one-to-one to colors of yellow (Y), magenta (M), cyan (C), and black (Bk). The charging portions 12Y, 12M, 12C, and 12K uniformly charge one-to-one the surfaces of the photoconductors 11Y, 11M, 11C, and 11K under the control of the image forming controller 205 of controller 200.

The exposure portions 13Y, 13M, 13C, and 13K are provided corresponding one-to-one to the colors of yellow (Y), magenta (M), cyan (C), and black (Bk). The exposure portions 13Y, 13M, 13C, and 13K are driven under the control of the image forming controller 205 of the controller 200 to form electrostatic latent images on the surfaces of the photoconductors 11Y, 11M, 11C, and 11K charged by the charging portions 12Y, 12M, 12C, and 12K.

The developing portions 14Y, 14M, 14C, and 14K are provided corresponding one-to-one to the colors of yellow (Y), magenta (M), cyan (C), and black (Bk). The developing portions 14Y, 14M, 14C, and 14K perform toner development on the electrostatic latent images formed on the surfaces of the photoconductors 11Y, 11M, 11C, and 11K by the exposure portions 13Y, 13M, 13C, and 13K under the control of the image forming controller 205 of the controller 200. The developing portions 14Y, 14M, 14C, and 14K develop the electrostatic latent images with toner and make the electrostatic latent images appear as toner images to form toner images on the surfaces of the photoconductors 11Y, 11M, 11C, and 11K.

The intermediate transfer belt 31 as a belt is stretched around rollers such as the driving roller 33, the tension roller 34, and a secondary-transfer inner roller 32 that is described later and that the secondary transfer portion 36 includes, and rotates in the direction of Arrow B in FIG. 1. On the intermediate transfer belt 31, the toner images of upstream colors formed on the surfaces of the photoconductors 11Y, 11M, 11C, and 11K are sequentially superimposed and primarily transferred by the primary transfer portions 35Y, 35M, 35C, and 35K, whereby a full-color toner image is formed. The intermediate transfer belt 31 bears the formed full-color toner image to convey the formed full-color toner image to the secondary transfer portion 36.

The intermediate transfer belt 31 is stretched around the driving roller 33 together with the rollers such as the tension roller 34 and the secondary-transfer inner roller 32 of the secondary transfer portion 36.

The intermediate transfer belt 31 is stretched around the tension roller 34 together with the rollers such as the driving roller 33 and the secondary-transfer inner roller 32 of the secondary transfer portion 36.

The primary transfer portions 35Y, 35M, 35C, and 35K are provided corresponding one-to-one to the colors of yellow (Y), magenta (M), cyan (C), and black (Bk). The primary transfer portions 35Y, 35M, 35C, and 35K applies predetermined pressure and electrostatic bias to primarily transfer the toner images formed on the surfaces of the photoconductors 11Y, 11M, 11C, and 11K onto the intermediate transfer belt 31.

The secondary transfer portion 36 includes the secondary-transfer inner roller 32 and a secondary-transfer outer roller 38 as a transfer member facing each other. The secondary transfer portion 36 forms a secondary-transfer nip portion 37 as a second nip portion with the secondary-transfer outer roller 38 abutting on the outer side of the intermediate transfer belt 31. The secondary transfer portion 36 applies, at the secondary-transfer nip portion 37, predetermined pressure and electrostatic bias to the sheet P that is conveyed by the pair of registration rollers 110 and passes through the secondary-transfer nip portion 37 to secondarily transfer the toner image formed on the intermediate transfer belt 31 onto the sheet P. The secondary transfer portion 36 conveys the sheet P to the air-suction conveying portion 42, while the sheet P with the toner image secondarily transferred thereon is nipped by the secondary-transfer outer roller 38 that drives and rotates due to transmission of a driving force by the secondary-transfer outer drive motor 39, together with the intermediate transfer belt 31.

The secondary-transfer outer drive motor 39 as a transfer roller driving portion is driven according to an instruction of the instruction signal received from a sheet conveying controller 206 that is described later and that the controller 200 includes, thereby transmitting the driving force to the secondary-transfer outer roller 38 to rotate the secondary-transfer outer roller 38. The driving is applied to the secondary-transfer outer roller 38, thereby resulting in reduction of transfer misalignment when the toner image is transferred onto the sheet P.

The air-suction conveying portion 42 conveys the sheet P conveyed by the secondary transfer portion 36 to the pair of fixing rollers 50.

The pair of fixing rollers 50 includes a fixing roller 51 and a pressure roller 52. The pair of fixing rollers 50 presses and heats the sheet P conveyed by the air-suction conveying portion 42 by the fixing roller 51 and the pressure roller 52 to melt and fix the toner image formed on the sheet P conveyed by the air-suction conveying portion 42 onto the sheet P. The pair of fixing rollers 50 conveys the sheet P with the toner image melted and fixed thereon to the pair of post-fixing rollers 53.

The pair of post-fixing rollers 53 conveys the sheet P conveyed by the pair of fixing rollers 50 to the pair of reversing first rollers 90 or the pair of discharge rollers 93.

In each of the sheet storage case 61, the sheet storage case 62, and the sheet storage case 63, a sheet P is stored for each size.

The sheet storage case 61 includes a sheet feeder 61a and a size detection mechanism 61d.

The sheet feeder 61a feeds the sheet P stored in the sheet storage case 61 to the pair of conveying rollers 130.

The size detection mechanism 61d detects the size of the sheet P stored in the sheet storage case 61, and outputs an electric signal corresponding to the detected size of the sheet P to a sensor controller 207 that is described later and that the controller 200 includes.

The sheet storage case 62 includes a sheet feeder 62a and a size detection mechanism 62d.

The sheet feeder 62a feeds the sheet P stored in the sheet storage case 62 to the pair of conveying rollers 130.

The size detection mechanism 62d detects the size of the sheet P stored in the sheet storage case 62, and outputs an electric signal corresponding to the detected size of the sheet P to the sensor controller 207 of the controller 200.

The sheet storage case 63 includes a sheet feeder 63a and a size detection mechanism 63d.

The sheet feeder 63a feeds the sheet P stored in the sheet storage case 63 to the pair of conveying rollers 130.

The size detection mechanism 63d detects the size of the sheet P stored in the sheet storage case 63, and outputs an electric signal corresponding to the detected size of the sheet P to the sensor controller 207 of the controller 200.

A sheet P is stacked on the manual feeding portion 64. The manual feeding portion 64 includes a sheet feeder 64a and a size detection mechanism 64d.

The sheet feeder 64a feeds the sheet P stacked on the manual feeding portion 64 to the pair of registration rollers 110.

The size detection mechanism 64d detects the size of the sheet P stacked on the manual feeding portion 64, and outputs an electric signal corresponding to the detected size of the sheet P to the sensor controller 207 of the controller 200.

The sheet feeding motor 65 is driven according to an instruction of the instruction signal received from the sheet conveying controller 206 that is described later and that the controller 200 includes. The sheet feeding motor 65 is driven to transmit a driving force to a pair of rollers of the sheet feeder 61a, a pair of rollers of the sheet feeder 62a, a pair of rollers of the sheet feeder 63a, or a pair of rollers of the sheet feeder 64a to rotate the pair of rollers of the sheet feeder 61a, the pair of rollers of the sheet feeder 62a, the pair of rollers of the sheet feeder 63a, or the pair of rollers of the sheet feeder 64a.

In the case of duplex printing in which each image is formed on one face as a first face and the other face as a second face of the sheet P, the pair of reversing first rollers 90 conveys the sheet P with the image is formed on the first face conveyed by the pair of post-fixing rollers 53 to the pair of reversing rollers 91.

The pair of reversing rollers 91 temporarily retracts the sheet P conveyed by the pair of reversing first rollers 90 using the reversing retraction portion 300, and switches back the temporarily retracted sheet P to convey the temporarily retracted sheet P to the duplex conveying portion 92. The pair of reversing rollers 91 performs the switchback and conveyance to switch the sheet P from the first face to the second face conveyed by the pair of reversing first rollers 90.

The duplex conveying portion 92 is connected to the pair of conveying rollers 130 closer to the upstream side than the secondary transfer portion 36 is, and reconveys the sheet P switched back and conveyed by the pair of reversing rollers 91 to the pair of conveying rollers 130.

The pair of discharge rollers 93 discharges the sheet P conveyed by the pair of post-fixing rollers 53 to the outside of the image forming apparatus 1.

The pair of registration rollers 110 includes a registration driving roller 113 as a first roller member and a registration driven roller 114 as a second roller member.

The registration driving roller 113 rotates due to driving of the registration drive motor 111, and stops rotating due to stop of the driving of the registration drive motor 111.

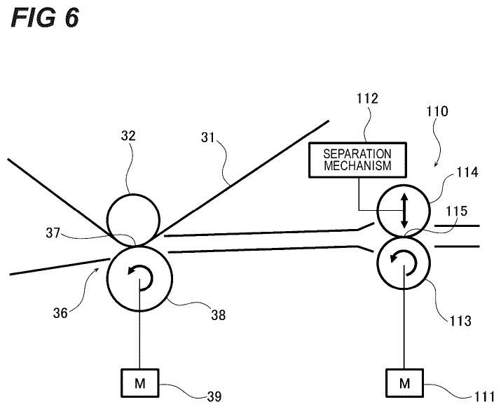

The registration driven roller 114 can abut on and can be separated from the registration driving roller 113 due to driving of the separation mechanism 112. The registration driven roller 114 forms a nip portion 115 (see FIG. 6) as a first nip portion between the registration driving roller 113 and the registration driven roller 114 with the registration driven roller 114 abutting on the registration driving roller 113, and is separated from the registration driving roller 113 to release the nip of the nip portion 115. The registration driven roller 114 is rotated following the registration driving roller 113.

The pair of registration rollers 110 comes into an abutment state due to the abutment of the registration driven roller 114 on the registration driving roller 113, and comes into a separated state due to the separation of the registration driven roller 114 from the registration driving roller 113.

In a driving stop state in which the registration driving roller 113 remains stopping its rotation, the pair of registration rollers 110 causes the sheet P conveyed by the pair of pre-registration rollers 120 to abut on the nip portion 115 to correct the tilt (skew feeding) with respect to the conveyance direction A of the sheet P. The pair of registration rollers 110 corrects the tilt (skew feeding) with respect to the conveyance direction A of the sheet P, and then causes the sheet P to stand by.

The registration driving roller 113 of the pair of registration rollers 110 starts rotating in order that the timing at which the toner image formed on the intermediate transfer belt 31 is conveyed to the secondary transfer portion 36 is synchronized with the timing at which the sheet P is conveyed to the secondary transfer portion 36. The registration driving roller 113 starts rotating and enters a driving state, so that the pair of registration rollers 110 conveys the sheet P to the secondary transfer portion 36 while the sheet P on standby is being nipped by the nip portion 115.

The distance between the nip portion 115 of the pair of registration rollers 110 and the secondary-transfer nip portion 37 of the secondary transfer portion 36 is shorter than the length in the conveyance direction A of a minimum-sized sheet P.

The registration drive motor 111 is driven according to an instruction of the instruction signal received from the sheet conveying controller 206 of the controller 200, thereby transmitting a driving force to the registration driving roller 113 of the pair of registration rollers 110 to rotate the registration driving roller 113.

The separation mechanism 112 is driven under the control of the separation controller 208 of the controller 200 to separate the registration driven roller 114 from the registration driving roller 113 of the pair of registration rollers 110 or cause the registration driven roller 114 to abut on the registration driving roller 113 of the pair of registration rollers 110. As a result, the separation mechanism 112 switches the pair of registration rollers 110 between the abutment state in which the nip portion 115 is formed and the separated state in which the nip of the nip portion 115 is released and the registration driven roller 114 is separated from the registration driving roller 113. At this time, the separation mechanism 112 separates the registration driven roller 114 from the registration driving roller 113 at a timing according to the thickness of the sheet P.

The pair of pre-registration rollers 120 as an upstream conveying roller faces the pair of registration rollers 110 on the upstream side in the conveyance direction A of the sheet P of the pair of registration rollers 110. The pair of pre-registration rollers 120 includes a pre-registration driving roller 122 as a third roller member and a pre-registration driven roller 123 as a fourth roller member.

The pre-registration driving roller 122 rotates due to driving of the pre-registration drive motor 121, and stops rotating due to stop of the driving of the pre-registration drive motor 121.

The pre-registration driven roller 123 forms a nip portion 124 (see FIG. 1) as a third nip portion between the pre-registration driving roller 122 and the pre-registration driven roller 123 with the pre-registration driven roller 123 abutting on the pre-registration driving roller 122. The pre-registration driven roller 123 is rotated following the pre-registration driving roller 122. The pre-registration driving roller 122 rotates due to transmission of a driving force from the pre-registration drive motor 121, and the pair of pre-registration rollers 120 conveys the sheet P conveyed by the pair of conveying rollers 130 to the pair of registration rollers 110.

The pre-registration drive motor 121 is driven according to an instruction of the instruction signal received from the sheet conveying controller 206 of the controller 200, thereby transmitting the driving force to the pre-registration driving roller 122 to rotate the pre-registration driving roller 122.

The pair of conveying rollers 130 conveys the sheet P fed from the sheet storage case 61, the sheet storage case 62, or the sheet storage case 63 to the pair of pre-registration rollers 120.

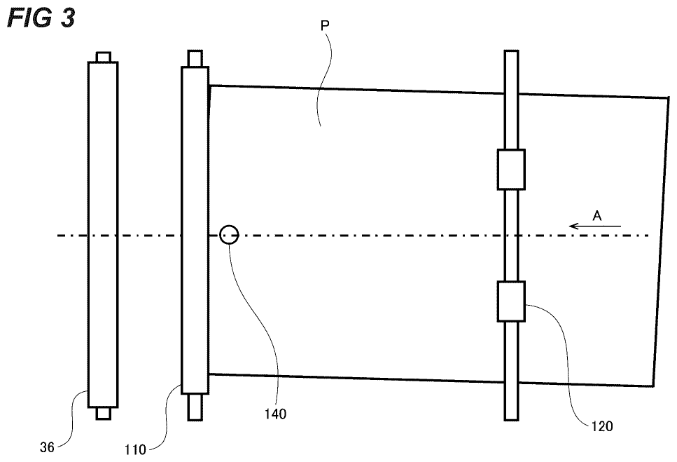

The registration sensor 140 is provided near the pair of registration rollers 110 between the pair of registration rollers 110 and the pair of pre-registration rollers 120 (see FIGS. 3 to 5). Under the control of the sensor controller 207 of the controller 200, the registration sensor 140 detects the sheet P conveyed by the pair of pre-registration rollers 120, or conveyed by the pair of pre-registration rollers 120 and the pair of registration rollers 110. The registration sensor 140 outputs an electric signal corresponding to the result of detection of the sheet P to the sensor controller 207 of the controller 200.

The controller 200 controls the entire operation of the image forming apparatus 1. The controller 200 includes a central processing unit (CPU) 201, a memory 202, the image forming controller 205, the sheet conveying controller 206, the sensor controller 207, and the separation controller 208.

Based on an electric signal received from the operation portion 203, the CPU 201 executes, for example, a predetermined control program stored in the memory 202, thereby controlling the operation of the image forming controller 205, the operation of the sheet conveying controller 206, or the operation of the sensor controller 207 to perform various processes. The CPU 201 controls the operation of the separation controller 208, based on the sheet information indicated by the electric signal received from the operation portion 203 and the result of detection by the registration sensor 140 acquired from the sensor controller 207. The CPU 201 may receive the sheet information from the computer 204 connected through the network, and may control the operation of the separation controller 208 based on the received sheet information.

The CPU 201 controls the operation of the separation controller 208 to bring the pair of registration rollers 110 into the separated state or the abutment state according to the basis weight of the sheet P conveyed to the secondary-transfer nip portion 37. Specifically, for conveyance of a thin sheet P having, as a basis weight, a first basis weight less than a predetermined value to the secondary-transfer nip portion 37, with the sheet P at a position to which the sheet P is conveyed by a predetermined distance after the leading end in the conveyance direction of the sheet P reaches the secondary-transfer nip portion 37, the CPU 201 controls the operation of the separation controller 208 to switch the pair of registration rollers 110 from the abutment state to the separated state. Further, for conveyance of a thick sheet P having, as a basis weight, a second basis weight not less than the predetermined value to the secondary-transfer nip portion 37, with the sheet P at a position to which the sheet P is conveyed to the predetermined distance after the leading end in the conveyance direction of the sheet P reaches the secondary-transfer nip portion 37, the CPU 201 causes the pair of registration rollers 110 to remain in the abutment state. Furthermore, for conveyance of the thick sheet P having, as the basis weight, the second basis weight not less than the predetermined value to the secondary-transfer nip portion 37, when the rear end in the conveyance direction of the sheet P passes through the pair of registration rollers 110, the CPU 201 controls the operation of the separation controller 208 to switch the pair of registration rollers 110 from the abutment state to the separated state.

The memory 202 is, for example, a random access memory (RAM) or a read only memory (ROM), and stores various programs and various pieces of data in a predetermined area of the memory 202.

The image forming controller 205 outputs an instruction signal to the image forming portion under the control of the CPU 201 to cause the image forming portion to perform an operation according to the instruction of the instruction signal.

According to the control of the CPU 201, the sheet conveying controller 206 outputs an instruction signal to the sheet feeding motor 65, the pre-registration drive motor 121, the registration drive motor 111, or the secondary-transfer outer drive motor 39 to control the conveyance of the sheet P.

The sensor controller 207 controls the operation of the size detection mechanism 61d, the operation of the size detection mechanism 62d, the operation of the size detection mechanism 63d, the operation of the size detection mechanism 64d, or the operation of the registration sensor 140. The sensor controller 207 controls the operation of each detection mechanism or the sensor to cause the size detection mechanism 61d, the size detection mechanism 62d, the size detection mechanism 63d, the size detection mechanism 64d, or the registration sensor 140 to start or stop detection. The sensor controller 207 outputs, to the CPU 201, the result of detection indicated by the electric signal received from the size detection mechanism 61d, the size detection mechanism 62d, the size detection mechanism 63d, the size detection mechanism 64d, or the registration sensor 140.

The separation controller 208 controls driving of the separation mechanism 112 under the control of the CPU 201.

The operation portion 203 receives an input operation by the user, such as sheet information regarding a sheet on which an image is to be formed or an instruction to execute printing or interrupt printing, and outputs an electric signal corresponding to the received input operation to the CPU 201.

The reversing retraction portion 300 is used for temporarily retracting the sheet P conveyed by the pair of reversing first rollers 90.

In the image forming apparatus 1 having the above configuration, the image forming portion executes image forming processes corresponding to the colors of Y, M, C, and Bk in parallel. Further, the image forming portion executes an image forming process at the timing of primarily transferring and superimposing the toner images in order from the upstream color to the same position on the intermediate transfer belt 31.

Further, a sheet P for image formation on the first face is fed from the sheet feeder 61a, the sheet feeder 62a, or the sheet feeder 63a and conveyed to the pair of registration rollers 110 after passing through the pair of pre-registration rollers 120, and the sheet P is then discharged outward by the pair of discharge rollers 93. Alternatively, a sheet P is fed from the sheet feeder 64a and conveyed to the pair of registration rollers 110, and is then discharged outward by the pair of discharge rollers 93.

Further, a sheet P for image formation on both of the first face and the second face is switched back and conveyed by the pair of reversing rollers 91 after the image formation on the first face, and is reconveyed toward the pair of conveying rollers 130 by the pair of reversing rollers 91 and the duplex conveying portion 92. Then, the sheet P conveyed toward the pair of conveying rollers 130 passes through the secondary transfer portion 36 and the pair of fixing rollers 50 and an image is formed on the second face, and is then discharged outward by the pair of discharge rollers 93.

### Skew-Feeding Correction Operation by Pair of Registration Rollers

The skew-feeding correction operation by the pair of registration rollers 110 of the image forming apparatus 1 according to the embodiment of the present disclosure will be described in detail with reference to FIGS. 3 to 5.

The sheet P is conveyed to the pair of registration rollers 110 after passing through the pair of pre-registration rollers 120, and the leading end in the conveyance direction A of the sheet P abuts on the pair of registration rollers 110 that remains stopping its rotation as illustrated in FIG. 3.

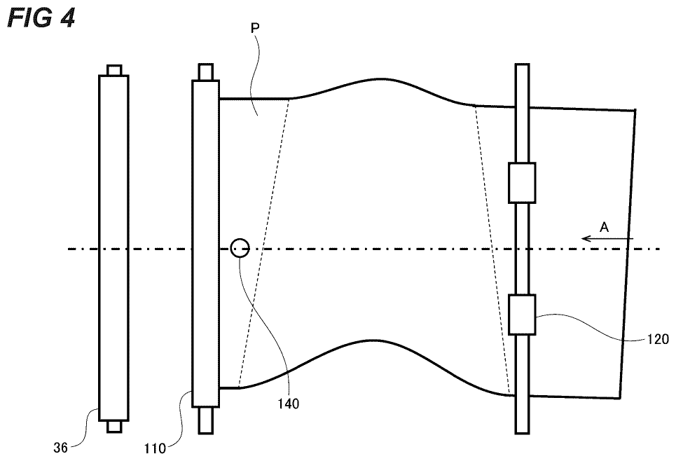

Next, the pair of pre-registration rollers 120 conveys the sheet P to slightly push the sheet P toward the pair of registration rollers 110. As a result, deflection (loop) occurs on the sheet P between the pair of pre-registration rollers 120 and the pair of registration rollers 110. Then, the sheet P tilting (skew feeding) with respect to the conveyance direction A when being conveyed to the pair of registration rollers 110 absorbs the skew feeding because there is a difference in the amount of loop in a direction orthogonal to the conveyance direction A. As a result, as illustrated in FIG. 4, the leading end in the conveyance direction A of the sheet P is along the nip portion 115 of the pair of registration rollers 110 and the skew feeding of the sheet P is corrected.

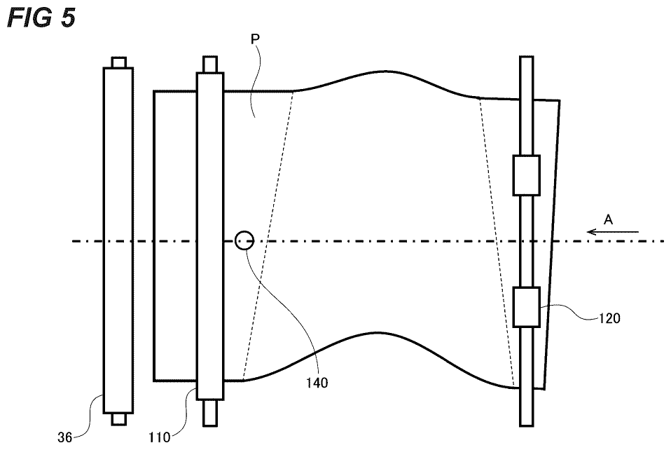

Next, as illustrated in FIG. 5, the registration driving roller 113 of the pair of registration rollers 110 starts rotating, so that the sheet P of which the skew feeding is corrected is conveyed to the secondary transfer portion 36.

Here, the sheet P is twisted due to the difference in the amount of loop in the direction orthogonal to the conveyance direction A. In a case where such a twist becomes too large to the stiffness (rigidity) of the sheet P, in conveyance of the sheet P by the pair of registration rollers 110, a twisted portion of the sheet P is stamped by the pair of registration rollers 110, so that damage such as wrinkles occurs on the sheet P. In particular, in the case of an ultra-thin sheet which specification is expected to be expanded in the future, the stiffness of the sheet P is weak, and thus damage may occur even with a slight twist.

Note that in a case where a twist with a predetermined amount or more occurs on a sheet thick to some extent, the reaction force applied from the sheet P to the pair of pre-registration rollers 120 increases. As a result, because the pair of pre-registration rollers 120 slides to the sheet P, the amount of twist of the sheet P is less likely to increase and damage to the sheet P is less likely to occur.

### Effects of Separation Operation and Effects of Performing Separation Operation by Pair of Registration Rollers

The effects of the separation operation and the effects of performing the separation operation by the pair of registration rollers 110 of the image forming apparatus 1 according to the embodiment of the present disclosure will be described in detail with reference to FIG. 6.

The separation mechanism 112 driven under the control of the separation controller 208 causes the registration driven roller 114 to separate from the registration driving roller 113 by the thickness of the sheet P or more, whereby the pair of registration rollers 110 releases the nip of the nip portion 115. Here, the thickness of the sheet P can be expressed by the basis weight of the sheet P.

Specifically, immediately after the leading end in the conveyance direction A of a thin sheet P having a thickness less than a predetermined value at which damage is likely to occur enters the secondary-transfer nip portion 37, the pair of registration rollers 110 releases the nip of the nip portion 115 to release the pressing of the sheet P by the nip portion 115. Here, such a thin sheet P having a thickness of less than the predetermined value is exemplified by a sheet P having a basis weight of less than 64 grams per square meter (gsm). As a result, the twist of the sheet P can be released before the pair of registration rollers 110 stamps a twisted portion of the sheet P, thereby resulting in prevention of damage to the sheet P.

At this time, the thin sheet P does not receive a conveying force from the pair of registration rollers 110, but can receive a conveying force from the secondary-transfer outer roller 38, so that the conveyance rate can be stabilized. As a result, a variation in magnification of an image formed on the thin sheet P can be prevented.

On the other hand, in the case of a thick sheet P having a thickness larger than that of the thin sheet P having the thickness less than the predetermined value, the contact force with a guide supporting the sheet P is larger, so that the conveyance resistance is larger. Therefore, in a case where the thick sheet P receives a conveying force from the secondary-transfer outer roller 38, the conveying force is insufficient and the conveyance rate may be unstabilized. Here, such a thick sheet P is exemplified by a sheet P having a basis weight of 128 gsm or more.

However, the thick sheet P is less likely to be twisted due to skew-feeding correction, and thus the timing of releasing the nip of the nip portion 115 of the pair of registration rollers 110 is delayed as compared with the thin sheet P. Therefore, the thick sheet P remains substantially nipped by the nip portion 115, and can receive a conveying force from both of the secondary-transfer outer roller 38 and the pair of registration rollers 110, so that the conveyance rate can be stabilized. As a result, a variation in magnification of an image formed on the thick sheet P can be prevented.

Here, the variation in magnification of the image due to the variation in conveyance rate of the sheet P on the secondary-transfer nip portion 37 is caused by the thickness of the sheet P, the surface property of the sheet P, and the difference in the toner density on the intermediate transfer belt 31. Further, the variation in magnification of the image is caused by a change in the conveyance rate of the sheet P due to a change in the conveying force received by the sheet P from the intermediate transfer belt 31, and a variation in the difference between the rate of the intermediate transfer belt 31 (toner image) and the conveyance rate of the sheet P.

In order to prevent such a variation in the conveyance rate of the sheet P with respect to the intermediate transfer belt 31, the image forming apparatus 1 causes the secondary-transfer outer drive motor 39 to rotate the secondary-transfer outer roller 38. As a result, the conveying force received by the sheet P on the secondary-transfer nip portion 37 is received not only from the intermediate transfer belt 31 but also from the secondary-transfer outer roller 38, so that the conveying force is larger and the conveyance rate of the sheet P is stabilized. In particular, the thin sheet P has a smaller conveyance resistance, and thus a sufficient conveying force can be received.

### Operation of Image Forming Apparatus

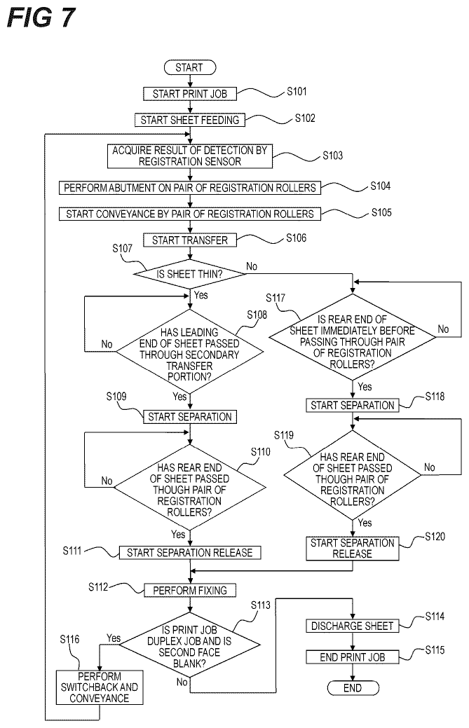

The operation of the image forming apparatus 1 according to the embodiment of the present disclosure will be described in detail with reference to FIG. 7.

The CPU 201 starts the operation illustrated in FIG. 7 at the timing when printing execution is instructed in an electric signal received from the operation portion 203 or a received signal received from the computer 204.

At this time, the CPU 201 acquires print information such as the number of copies or sheet information in the electric signal received from the operation portion 203 or the received signal received from the computer 204. Further, the CPU 201 acquires, from the sensor controller 207, information on the size of the sheet P stored in the sheet storage case 61, the sheet storage case 62, or the sheet storage case 63, or stacked on the manual feeding portion 64.

First, the CPU 201 starts a print job (S101).

Next, the CPU 201 controls the operation of the sheet conveying controller 206, and causes the pair of rollers of the sheet feeder 61a, the pair of rollers of the sheet feeder 62a, the pair of rollers of the sheet feeder 63a, or the pair of rollers of the sheet feeder 64a storing or stacking the sheet P having the size in the sheet information to rotate and start feeding of the sheet P (S102). As a result, the fed sheet P is conveyed to the pair of pre-registration rollers 120.

Next, the CPU 201 acquires the result of detection that the registration sensor 140 has detected the leading end in the conveyance direction A of the sheet P from the sensor controller 207 (S103).

Next, the CPU 201 controls the operation of the sheet conveying controller 206 to stop the driving of the registration drive motor 111 and stop the rotation of the registration driving roller 113 of the pair of registration rollers 110. The CPU 201 stops the rotation of the registration driving roller 113 to cause the sheet P to abut on the nip portion 115 of the pair of registration rollers 110 (S104).

The sheet P abutting on the nip portion 115 is conveyed by an amount of feeding set by the pair of pre-registration rollers 120. As a result, the pair of registration rollers 110 can form a predetermined amount of deflection as illustrated in FIG. 4 on the sheet P, for example, rotated clockwise and skew-fed with respect to the conveyance direction A illustrated in FIG. 3, and thus, can correct the skew feeding of the sheet P.

Next, the CPU 201 controls the operation of the sheet conveying controller 206 to drive the registration drive motor 111. The CPU 201 causes the registration drive motor 111 to drive, so that a driving force of the registration drive motor 111 is transmitted to the registration driving roller 113, and the pair of registration rollers 110 starts conveying the sheet P (S105). As a result, the sheet P is conveyed by the pair of registration rollers 110 to the secondary transfer portion 36.

Next, the CPU 201 controls the operation of the image forming controller 205 to cause the secondary transfer portion 36 to transfer the toner image formed on the intermediate transfer belt 31 to the sheet P (S106).

Next, the CPU 201 determines whether or not the sheet P is thin, based on the sheet information of the sheet P acquired from the operation portion 203 or the computer 204 (S107). Specifically, the CPU 201 determines whether or not the basis weight of the sheet P is less than a predetermined value. For example, the CPU 201 determines whether or not the basis weight of the sheet P is less than 64 gsm.

In a case where the sheet P is thin (step S107: Yes), the CPU 201 determines whether or not the leading end in the conveyance direction A of the sheet P has passed through the secondary transfer portion 36 (S108). Specifically, the CPU 201 determines that the sheet P is a thin sheet P having, as the basis weight, a first basis weight less than a predetermined value, and determines whether or not the leading end in the conveyance direction A of the sheet P has passed through the secondary transfer portion 36. In addition, the memory 202 prestores time information regarding a predetermined duration from the detection of the leading end in the conveyance direction A of the sheet P by the registration sensor 140 to the passing of the leading end in the conveyance direction A of the sheet P through the secondary transfer portion 36. The CPU 201 refers to the time information stored in the memory 202, and determines whether or not the predetermined duration from the detection of the leading end in the conveyance direction A of the sheet P by the registration sensor 140 has elapsed.

The CPU 201 determines whether or not the predetermined duration has elapsed, and determines whether or not the leading end in the conveyance direction A of the sheet P has passed through the secondary transfer portion 36. Note that the predetermined duration can be obtained in advance by a preset conveyance rate and the distance between the registration sensor 140 and the secondary-transfer nip portion 37 of the secondary transfer portion 36.

In a case where the leading end in the conveyance direction A of the sheet P has not passed through the secondary transfer portion 36 (step S108: No), the CPU 201 repeats the process of step S108.

Otherwise, in a case where the leading end in the conveyance direction A of the sheet P has passed through the secondary transfer portion 36 (step S108: Yes), the CPU 201 controls the operation of the separation controller 208 to drive the separation mechanism 112. The CPU 201 causes the separation mechanism 112 to drive, so that the registration driven roller 114 is separated from the registration driving roller 113 (S109). As a result, the nip of the nip portion 115 of the pair of registration rollers 110 to the sheet P can be released, and the twist occurring on the sheet P between the pair of registration rollers 110 and the pair of pre-registration rollers 120 can be released.

Next, based on the result of detection by the registration sensor 140 acquired from the sensor controller 207, the CPU 201 determines whether or not the rear end in the conveyance direction A of the sheet P has passed through the nip portion 115 of the pair of registration rollers 110 (S110). Specifically, the memory 202 prestores time information regarding a predetermined duration from the detection of the rear end in the conveyance direction A of the sheet P by the registration sensor 140 to the passing of the rear end in the conveyance direction A of the sheet P through the pair of registration rollers 110.

The CPU 201 refers to the time information stored in the memory 202, and determines whether or not the predetermined duration from the detection of the rear end in the conveyance direction A of the sheet P by the registration sensor 140 has elapsed. The CPU 201 determines whether or not the predetermined duration from the detection of the rear end in the conveyance direction A of the sheet P by the registration sensor 140 has elapsed, and determines whether or not the rear end in the conveyance direction A of the sheet P has passed through the pair of registration rollers 110. Note that the predetermined duration can be obtained in advance by a preset conveyance rate and the distance between the registration sensor 140 and the nip portion 115 of the pair of registration rollers 110.

In a case where the rear end in the conveyance direction A of the sheet P has not passed through the nip portion 115 (step S110: No), the CPU 201 repeats the process of step S110.

Otherwise, in a case where the rear end in the conveyance direction A of the sheet P has passed through the nip portion 115 (step S110: Yes), the CPU 201 controls the operation of the separation controller 208 to drive the separation mechanism 112.

The CPU 201 causes the separation mechanism 112 to drive, so that the registration driven roller 114 abuts on the registration driving roller 113 and the separation of the registration driven roller 114 from the registration driving roller 113 is released (S111).

Next, the CPU 201 controls the operation of the image forming controller 205 to fix the toner image secondarily transferred to the sheet P in the secondary transfer portion 36 by the pair of fixing rollers 50 onto the sheet P (S112).

Next, the CPU 201 determines whether or not the print job is a duplex job and the second face is blank (S113).

In a case where the print job is a single-sided job or a duplex job and printing has been performed on both of the first face and the second face (step S113: No), the CPU 201 controls the operation of the sheet conveying controller 206 to discharge the sheet P with the toner image fixed thereon to the outside of the image forming apparatus 1 by the pair of discharge rollers 93 (S114).

Next, the CPU 201 ends the print job (S115) to end the operation.

Otherwise, in a case where the print job is a duplex job and the second face is blank (step S113: Yes) in the operation of step S113, the CPU 201 controls the operation of the sheet conveying controller 206 to cause the pair of reversing rollers 91 to switch back and convey the sheet P. Further, the CPU 201 causes the duplex conveying portion 92 to convey the sheet P to the pair of pre-registration rollers 120 (S116). Thereafter, the CPU 201 returns to the operation of step S103.

However, in the operation of step S107, in a case where the sheet P is a thick sheet (step S107: No), the CPU 201 acquires the result of detection by the registration sensor 140 from the sensor controller 207. Specifically, in a case where the basis weight of the sheet P is the second basis weight larger than the first basis weight of a predetermined value or more, the CPU 201 determines that the sheet P is thick, and acquires the result of detection by the registration sensor 140 from the sensor controller 207. Then, based on the acquired result of detection by the registration sensor 140, the CPU 201 determines whether or not the registration sensor 140 has detected the rear end in the conveyance direction A of the sheet P (S117).

In a case where the registration sensor 140 has not detected the rear end in the conveyance direction A of the sheet P (step S117: No), the CPU 201 repeats the operation of step S117.

Otherwise, in a case where the registration sensor 140 has detected the rear end in the conveyance direction A of the sheet P (step S117: Yes), the CPU 201 controls the operation of the separation controller 208 to drive the separation mechanism 112. The CPU 201 causes the separation mechanism 112 to drive, so that the registration driven roller 114 is separated from the registration driving roller 113 (S118).

As described above, in a case where the thick sheet P is conveyed, the pair of registration rollers 110 applies a conveying force to the sheet P to the vicinity of the rear end in the conveyance direction A of the sheet P, and thus the conveyance rate of the sheet P can be stabilized. In addition, in a case where the rear end in the conveyance direction A of the sheet P passes through the nip portion 115 while the sheet P is being nipped by the nip portion 115 of the pair of registration rollers 110, a steep variation in rate may occur in the sheet P. However, the nip of the nip portion 115 is released immediately before the rear end in the conveyance direction A of the sheet P passes through the nip portion 115, whereby the steep variation in rate of the sheet P can be prevented.

Next, based on the result of detection by the registration sensor 140 acquired from the sensor controller 207, the CPU 201 determines whether or not the rear end in the conveyance direction A of the sheet P has passed through the nip portion 115 of the pair of pair of registration rollers 110 (S119).

In a case where the rear end in the conveyance direction A of the sheet P has not passed through the nip portion 115 (step S119: No), the CPU 201 repeats the step of S119.

Otherwise, in a case where the rear end in the conveyance direction A of the sheet P has passed through the nip portion 115 (step S119: Yes), the CPU 201 controls the operation of the separation controller 208 to drive the separation mechanism 112. The CPU 201 causes the separation mechanism 112 to drive, so that the registration driven roller 114 abuts on the registration driving roller 113 and the separation of the registration driven roller 114 from the registration driving roller 113 is released (S120). Thereafter, the CPU 201 performs the operation of step S112 or later.

As described above, the timing at which the registration driven roller 114 is separated from the registration driving roller 113 is later for the thick sheet P than for the thin sheet P. As a result, for both of the thin sheet P having a smaller conveyance resistance and being likely to be damaged and the thick sheet P having a larger conveyance resistance and being less likely to be damaged, the variation in the conveyance rate and damage to the sheet P can be both prevented.

In the above operation, for conveyance of the thin sheet P, the rotation speed of the pair of pre-registration rollers 120 disposed upstream of the pair of registration rollers 110 may be increased in parallel with the operation of releasing the nip of the nip portion 115 of the pair of registration rollers 110. Specifically, in parallel with the operation of step S109, the CPU 201 controls the operation of the sheet conveying controller 206 to make the rotation speed of the pair of pre-registration rollers 120 faster than that before releasing the nip of the nip portion 115. As a result, a decrease in the conveying force due to the release of the nip of the nip portion 115 can be compensated.

Further, when the pair of registration rollers 110 starts conveyance, the nip of the nip portion 124 of the pair of pre-registration rollers 120 upstream in the conveyance direction A of the sheet P of the pair of registration rollers 110 may be released. Specifically, in parallel with the operation of step S109, the CPU 201 causes a separation mechanism that makes abutment and separation between the pre-registration driving roller 122 and the pre-registration driven roller 123 to release the nip of the nip portion 124 of the pair of pre-registration rollers 120. As a result, the space for releasing the twist of the sheet P can be widened, and the twist due to larger skew feeding of the sheet P can be released.

Note that in the above operation, when the rear end in the conveyance direction A of the sheet P passes through the nip portion 115 while the sheet P is being nipped by the nip portion 115, in a case where a steep variation in rate does not occur in the sheet P, the operations of steps S117 to S120 is not necessarily be performed. In this case, the operations from step S107 to step S112 are skipped.

Further, in the operation of step S107 described above, the sheet P different from the thin sheet P is determined as the thick sheet P. However, the present disclosure is not limited thereto, and thus the sheet P may be determined as a thick sheet in a case where the sheet P has a thickness of a predetermined value or more. For example, in a case where the CPU 201 determines that the basis weight of the sheet P is 64 gsm or more as the first basis weight in the operation of step S107, the CPU 201 may further determine whether or not the basis weight of the sheet P is 128 gsm or more as the second basis weight larger than the first basis weight, and may determine that the sheet P having the basis weight of 128 gsm or more is a thick sheet P. Then, in a case where the CPU 201 determines the sheet P as the thick sheet P, the CPU 201 performs the operations of step S117 to step S120.

In the present embodiment, for conveyance of the sheet P having, as the basis weight, the first basis weight to the secondary-transfer nip portion 37, the driving of the separation mechanism 112 is controlled to bring the pair of registration rollers 110 into the separated state. On the other hand, for conveyance of the sheet P having, as the basis weight, the second basis weight larger than the first basis weight to the secondary-transfer nip portion 37, the driving of the separation mechanism 112 is controlled to bring the pair of registration rollers 110 into the abutment state. As a result, an image formed on the sheet P can be prevented from being stretched and shrunk in the conveyance direction A of the sheet P and damage to the sheet P by the pair of registration rollers 110 can be prevented.

The present disclosure is not limited to the above embodiment, and thus it is obvious that various modifications can be made without departing from the gist of the present disclosure.

Specifically, in the above embodiment, the sheet P having the basis weight of less than 64 gsm is the thin sheet P, but the present disclosure is not limited thereto, and thus a sheet P having a basis weight of less than a value different from 64 gsm may be the thin sheet P.

Further, in the above embodiment, the sheet P having the basis weight of 64 gsm or more or 128 gsm or more is the thick sheet P, but the present disclosure is not limited thereto, and thus a sheet P having a basis weight of a value different from 64 gsm or more and different from 128 gsm or more may be the thick sheet P.

According to the present disclosure, an image formed on a sheet can be prevented from being stretched and shrunk in the conveyance direction of the sheet and damage to the sheet by the pair of registration rollers can be prevented.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-130760, filed Aug. 7, 2024, which is hereby incorporated by reference herein in its entirety.

What is claimed is:

1. An image forming apparatus comprising:
an image forming portion configured to form a toner image;
a pair of registration rollers including a first roller member, and a second roller member forming a first nip portion with the second roller member abutting on the first roller member, the pair of registration rollers being configured to convey a sheet while the sheet is being nipped by the first nip portion, and correct skew feeding of the sheet due to abutment of a leading end in a conveyance direction of the sheet on the first nip portion;
a separation mechanism configured to switch the pair of registration rollers between an abutment state in which the first nip portion is formed with the first roller member and the second roller member abutting on each other and a separated state in which the first nip portion is separated;
a transfer portion including a belt configured to bear the toner image formed by the image forming portion, a transfer member forming a second nip portion with the transfer member abutting on an outer side of the belt, and a driving portion configured to drive the transfer member to rotate, the transfer portion being configured to transfer the toner image onto the sheet while the sheet is passing through the second nip portion after the correction of the skew feeding of the sheet by the pair of registration rollers; and
a controller configured to control the separation mechanism, wherein
for conveyance of the sheet having a first basis weight as a basis weight to the second nip portion, the pair of registration rollers is in the separated state with the sheet at a position to which the sheet is conveyed by a predetermined distance after the leading end in the conveyance direction of the sheet reaches the second nip portion, and
for conveyance of the sheet having, as the basis weight, a second basis weight larger than the first basis weight to the second nip portion, the pair of registration rollers is in the abutment state with the sheet at the position to which the sheet is conveyed by the predetermined distance after the leading end in the conveyance direction of the sheet reaches the second nip portion.

2. The image forming apparatus according to claim 1, wherein
for the conveyance of the sheet having the second basis weight as the basis weight to the second nip portion, when a rear end in the conveyance direction of the sheet passes through the pair of registration rollers,
the controller
is configured to control driving of the separation mechanism to switch the pair of registration rollers from the abutment state to the separated state.

3. The image forming apparatus according to claim 1, further comprising an upstream conveying roller provided upstream of the pair of registration rollers in the conveyance direction, the upstream conveying roller being configured to convey the sheet, wherein
the controller
makes a conveyance rate of the sheet of the upstream conveying roller faster in a case where the first nip portion is separated than in a case where the first nip portion is not separated.

4. The image forming apparatus according to claim 1, further comprising an upstream conveying roller including: a third roller member; and a fourth roller member forming a third nip portion with the fourth roller member abutting on the third roller member, the upstream conveying roller facing the pair of registration rollers upstream of the pair of registration rollers in the conveyance direction, the upstream roller being configured to convey the sheet while the sheet is being nipped by the third nip portion, and separate the third nip portion in a case where the first nip portion is separated.
